(19) United States
(12) Patent Application Publication
(10) Pub. No.: US 2016/0359793 A1
(43) Pub. Date: Dec. 8, 2016

(54) SYSTEMS AND METHODS FOR CREATION, DELIVERY AND TRACKING OF ELECTRONIC MESSAGES

(71) Applicant: 250ok LLC, Indianapolis, IN (US)

(72) Inventor: Gregory James KRAIOS, Speedway, IN (US)

(21) Appl. No.: 15/175,076

(22) Filed: Jun. 7, 2016

Related U.S. Application Data
(60) Provisional application No. 62/172,262, filed on Jun. 8, 2015.
(60) Provisional application No. 62/237,480, filed on Oct. 5, 2015.

(51) Int. Cl. H04L 12/58

(52) U.S. Cl. CPC H04L 51/34; H04L 51/08

(57) ABSTRACT

An architecture and methods for monitoring delivery of multiple email messages is provided. The architecture includes and integrates a plurality of techniques for collecting and presenting information, including monitoring delivery statistics, assessing ongoing sender reputation, and providing feedback on appearance of delivered email on a variety of devices and platforms. A feature of the methods described is the integration of information from multiple monitoring processes to improve, enhance, and enrich the other processes. An aspect of the architecture includes the time sensitivity of messages and campaigns.

### CROSS-REFERENCE TO RELATED APPLICATIONS

The present application claims priority under 35 U.S.C. §119 of U.S. Provisional Patent Application Ser. No. 62/172,262, filed Jun. 8, 2015, and 62/237,480, filed Oct. 5, 2015, the disclosures of which are incorporated by reference herein.

### BACKGROUND

1. Field of the Invention

The field of the invention relates generally to electronic communications using computer networks and more particularly to creation, delivery and monitoring of multiple electronic mail messages.

2. Background Art

Businesses and organizations desire to communicate and conduct transactions with existing and potential customers. As technology evolves, new technology is adopted as a means of connecting and interacting with customers. However, effective application of new technology brings new challenges as well as additional opportunities.

One of the earliest and most important applications of computer networks was electronic messaging, often referred to as “email.” With the expansion of the Internet to reach many homes and businesses, email and network technology emerged as an attractive, efficient and effective means of communication, advertising, and conducting business.

However users quickly became overwhelmed with messages that were annoying, unwelcome, and in some cases fraudulent or malicious. Increasingly sophisticated schemes were directed at tricking users into disclosing personal or secure information. Thus, a variety of email filters were implemented to block messages that were not wanted.

This creates an issue for legitimate email senders of bulk email in that valid messages are sometimes blocked. Senders often have no way to know if they are being blocked, or if they are blocked, may not determine the extent of the blockage or the source of the filter that caused sites to doubt the validity of messages or the reputation of the sender, thus have difficulty challenging the rejection or revising their message content to avoid filters.

An additional challenge appeared with the proliferation of communication devices, display sizes, and versions of operating systems and software. It is difficult for a sender of an email message to know how a given message appears to users on different devices.

Conventional approaches to these challenges have used a number of ad hoc techniques to assess email delivery rates and filters. Some conventional techniques rely on receiving notices of undeliverable mail returned from remote servers. Others send probe messages to a known set of mail servers or mailboxes.

A primary activity of an email marketer has been to match lists of email addresses (“list”) with graphic & written collateral (“marketing email”) for the purpose of conducting a mass-mailing to email recipients (“campaign”) in the hopes of achieving a specific goal such as selling something, signing up users to a service, and so on (“conversion”). While modern email marketing software has made this easier and in some cases completely automated, the basic procedure is unchanged. Among the difficulties arising in sending a high volume of campaigns are: (1) Monitoring email placement (Where a message is delivered, usually the inbox, spam folder, or not at all) at recipient domains (e.g. gmail.com), and (2) Correlating email placement information with other email intelligence signals (IP and Domain reputation, spam filter reports, email authentication data, abuse metrics, etc.) to diagnose and understand placement issues.

Addressing these difficulties is beyond the ability of contemporary email marketers, and falls to dedicated deliverability analysts (IP and Domain reputation, spam filter reports, email authentication data, abuse metrics, etc.). To enable email marketers to self-monitor, commercial products employing a technique called seed testing have been developed and marketed.

The essence of seed testing is simple: add a set of email addresses to your list that are monitored by software-based seed testing programs instead of a human recipient. The seed testing program notes on a per-domain basis whether and where the marketing emails were delivered and produces a report similar to the following:

| | Inbox | Spam | Missing |
|---|---|---|---|
| Gmail | 80% | 15% | 5% |
| Hotmail | 100% | 0% | 0% |
| . . . | . . . | . . . | . . . |

The essence of seed testing is simple: add a set of email addresses to your list that are monitored by software-based seed testing programs instead of a human recipient. The seed testing program notes on a per-domain basis whether and where the marketing emails were delivered and produces a report similar to the following:

| | Inbox | Spam | Missing |
|---|---|---|---|
| Gmail | 80% | 15% | 5% |
| Hotmail | 100% | 0% | 0% |
| . . . | . . . | . . . | . . . |

Problems with these systems include the following:

1. Backend Obfuscation. The modern internet is a collection of user-facing services (e.g. websites, email providers, software-as-a-service products, etc.) often composed from commoditized backend services. For example, incoming messages to the fictitious private domain bar.com (this term describing a recipient domain belonging to a private company/entity, as opposed to a mailbox service such as Gmail, Verizon, Hotmail, and so on) might actually be scanned by a reputation/spam filter provided by Cloudmark, checked for compliance & malware by Cisco Cloud Services, and finally delivered to a mailbox hosted by Microsoft Office 365. Impact: Failure to correlate problems at a given domain with problems at all private domains sharing similar backend services, making it appear as if the problems seen at such domains are distinct and unrelated, hindering swift identification and remediation of the core problem.

2. False Positives. Because existing seed testing products test all domains they monitor, consumers get results from seed addresses regardless of where they actually send messages. Impact: Frequent reports of deliverability problems at recipient domains not present in the consumer's lists, and not sent to by the consumer.

3. Common Domain. The common domain problem is the failure to discern that many recipient domains that appear dissimilar are in fact semantically identical. For example, hotmail.co.uk and hotmail.com use the same delivery infrastructure. Similarly, Google Applications allows any domain to leverage the Gmail email delivery infrastructure. Office 365 and Outlook.com provide a similar service for Microsoft customers. Impact: The computed accuracy (e.g. what is my performance at Hotmail?) of seed testing is diminished due to an oversized denominator (e.g. the total count of represented domains), resulting over/under statement of results.

4. Proportional Weighting. Current seed testing products do not present seed test results taking customer list composition into account, and therefore cannot provide insight into the true meaning and severity of negative results across the domains in the customer's list. For commercial email senders, email must be delivered to the inbox to have the highest probability of conversion and subsequent revenue generation. Recipient domains with the highest representation in the customer's list therefore represent the highest revenue opportunity, thus the highest-priority for deliverability investigations. Impact: Marketers are forced to treat all deliverability problems equally, spending time & money to resolve them all instead of focusing on the highest-ROI domains first.

The current generation of seed testing tools at best misrepresent the true state of deliverability and at worst cause users to focus on problems that don't need to be resolved, missing the ones that do. Further, they don't go far enough into the actual list itself to identify problems with the contents of the list that contribute to poor deliverability. It may be seen from the foregoing that there is a need for an improved system to permit email senders to know if messages are delivered, the time for delivery, the appearance of delivered messages, and the reputation of the sender.

### SUMMARY OF THE INVENTION

Described herein are methods for tracking and monitoring various aspects of delivery of email to multiple users and presenting the results so that they are informative and interactive. It is also a feature of the architecture and methods provided herein to integrate data from multiple monitoring operations to provide additional capability through fusion of data. These and other features, aspects, and embodiments of the invention are described below.

The List Analysis technology involved in embodiments of the present invention relate to the Seedlist Optimizer: a tool allowing users to customize Inbox Informant's behavior by creating seedlists tailored to the composition of their lists, driven by proprietary analysis of the recipient domains contained in the lists, addressing the previously described problems, then by presentation of seed test results based on weighting determined during seedlist creation.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a high-level depiction of an architecture and operations according an embodiment of the descriptions herein,

FIG. 2 illustrates a sequence and arrangement of operations according to an embodiment;

FIG. 3 depicts a flow of operations according to an embodiment of the descriptions herein;

FIG. 4 illustrates a configuration of email servers according to an embodiment according to the descriptions herein;

FIGS. 5A, 5B, and 5C schematically depict schemes for matching messages according to an embodiment of the features and descriptions herein;

FIG. 6 depicts a flow chart according to the descriptions herein for initiating a new email campaign;

FIG. 7 depicts an additional flow chart according to an embodiment of the descriptions herein;

FIG. 8 depicts an arrangement of components and operations to implement an embodiment of the descriptions herein;

FIG. 9 further depicts an arrangement of components according to an embodiment of the descriptions herein;

FIG. 10 illustrates a data structure according to an embodiment of the descriptions herein;

FIG. 11 depicts a flow chart according to embodiments described herein for updating a reputation impression;

FIG. 12 depicts a flow chart according to embodiments described herein;

FIG. 13 schematically depicts an arrangement of components according to an embodiment of the descriptions herein to insert and apply code to perform email tracking and obtain feedback information;

FIGS. 14A and 14B depict flow charts according to an embodiment of the descriptions herein for mapping among lists of addresses, IP addresses and ISPs.

FIG. 15 depicts an illustrative network computer arrangement.

FIG. 16 depicts an illustrative schematic diagram of computing equipment suitable for various computing devices and servers.

FIGS. 17-21 are screen shots of a list analyzer feature of one embodiment of the present invention.

FIGS. 22 and 23 are tables showing list analyzer features of one embodiment of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DETAILED DESCRIPTION OF EMBODIMENTS OF THE INVENTION

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The apparatus may also comprise a “cluster,” wherein multiple computers with an interconnecting data network are configured to act in concert for the required purpose. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system may be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which may be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks may access the network resources, such as shared data files, common peripheral devices, and inter-workstation communication. However, with increasing capacity of computers, in some cases the capabilities of a “server” may be implemented with an ordinary personal computer, either as an application program or as a state machine running in a Browser. In such cases, it may even be possible that a “workstation” may provide a user interface at the same time a separate state machine running in a Browser on the “workstation” may function as a separate “server”.

Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis.

The terms “windows” and associated terms such as “windowing environment” or “running in windows” defined above refer to a computer user interface, exemplified by the several windowing systems available from Microsoft Corporation of Redmond, Wash. Other windows computer interfaces are available, for example from Apple Computers Incorporated of Cupertino, Calif. and as components of the Linux operating environment. In particular it should be understood that the use of these terms in the descriptions herein does not imply a limitation to any particular computing environment or operating system.

The terms “desktop”, “personal desktop facility”, and “PDF” mean a specific user interface which presents a menu or display of objects with associated settings for the user associated with the desktop, personal desktop facility, or PDF. When the PDF accesses a network resource, which typically requires an application program to execute on the remote server, the PDF calls an Application Program Interface, or “API”, to allow the user to provide commands to the network resource and observe any output.

The term “Browser” refers to a program which is not necessarily apparent to the user, but which is responsible for transmitting messages between the PDF and the network server and for displaying and interacting with the network user. Browsers are designed to utilize a communications protocol for transmission of text and graphic information over a world wide network of computers, namely the “World Wide Web” or simply the “Web”. In addition, a Browser may also be enabled to interpret various levels of computer code and execute that code on the computer on which it is running. In such a case, the Browser may create several processes, and may function as a state machine separate and distinct from the user interface or network server. Examples of Browsers compatible with the present invention include the Internet Explorer program sold by Microsoft Corporation (Internet Explorer is a trademark of Microsoft Corporation), the Opera Browser program created by Opera Software ASA, or the Firefox browser program distributed by the Mozilla Foundation (Firefox is a registered trademark of the Mozilla Foundation). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a handheld device and a desktop computer either via wires or wirelessly. Synchronization ensures that the data on both the handheld device and the desktop computer are identical.

In wireless wide area networks, communication primarily occurs through the transmission of radio signals over analog, digital cellular, or personal communications service (“PCS”) networks. Signals may also be transmitted through microwaves and other electromagnetic waves. The electromagnetic waves used for communication may include “optical” waves at visual or near-visual frequencies, transmitted through free space or using “optical fibers” as a waveguide. At the present time, most wireless data communication takes place across cellular systems using technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (CDPD″) used on the Advance Mobile Phone Service (“AMPS”).

The term “real-time” (also “realtime”) or “near real-time” means a system design approach that uses timing as a primary design objective. In particular, a real-time system completes one or more operations within a time interval that meets predetermined criteria. The term may also be used to refer to an operation performed, for example an “update in real-time.” The time interval criteria may be a specific amount of time, or may be defined in contrast to another non-real-time system, sometimes referred to as “batch” or “offline” system.

It may be appreciated that the time interval is determined by requirements that vary among systems. For example, a high-performance aircraft real-time control system may be required to respond in microseconds, while for a real-time reservoir level regulator update intervals of hours may be acceptable. In interactions with a human user, a system providing “real-time response” means a user receives a response to an input quickly enough to allow interactive or “live” use of the system without an unacceptable delay (typically, a user might accept a delay of less than a second for transactions that are expected to be immediate, while a user might accept a delay of a minute for a complicated transaction requiring interaction with a remote site).

In the descriptions herein, real-time transaction processing means that the system is designed to rapidly complete an operation that affects system data and the resulting changed data is made available to other system components as rapidly as possible, without requiring an offline synchronization process. It may be appreciated that the exact timing of such a system is dependent on a number of factors such as processing time and propagation of data across networks, but that the salient characteristic is rapid availability of data modified as a result of a transaction event.

The descriptions herein refer to aspects of delivery of electronic messages using computers and networks so some terms related to these descriptions have specialized meanings. An email or email message is a file or collection of electronic data or computer instructions that are intended to communicate between a sender and a receiver. A receiver is also termed a recipient or viewer. An email message typically is divided into a header, a body and one or more attachments. The header is primarily intended to provide delivery and sender information, for example names and addresses of sender and recipient, where to reply, dates, and the like. The body typically is the bulk of the content to be delivered and while message bodies were originally plain text characters, email has now evolved to include various character sets, fonts, colors, types, images, and other media. Media may be included directly or by a link to an external server, for example in the form of a URL or URI. MIME encoding is another method of including multimedia content.

Email communication across the variety of servers and devices found on the Internet and World Wide Web is possible due to a comprehensive set of standards. These standards are defined in documents known as “RFCs” available widely on the Internet.

Unwelcome or annoying email is termed SPAM or junk. Various malicious types of email exist including phishing wherein the email misrepresents its purpose to trick a recipient into revealing secure or sensitive information.

In reference to email, reputation refers to the presence or absence of the sender's addresses in repositories web servers that identify SPAM senders in response to queries.

Destination addresses are specified as a concatenation of a name field and a domain field, separated by the “@” character. The domain field refers to a destination such as an organization or service provider, while the name field specifies a unique user in that domain. For delivery, a domain is translated to an Internet Protocol (IP) address, by querying the Domain Name System (DNS). One piece of information available from the DNS is the Mail Exchanger record (MX). Obtaining the MX record or records corresponding to a domain name provides the IP address of the email server or servers to be used to send email to users in that domain. MX records are often associated with a time duration indicating how long they remain authoritative, often termed “time to live” or TTL.

A number of standards exist for specifying IP addresses, including IPv4 and IPv6 formats wherein a large number is divided into octets or bytes and some of the higher order bytes indicate a network and lower bytes indicate a specific host within the network. The number of bytes for network and host is defined by the class of the address. More recently classless internet address specifiers have been used, also known as CIDRs.

Email messages are passed from sender to recipient using networks of servers, using a store and forward model. At the final destination messages are delivered to a user's mailbox or inbox where they may be previewed and wait for the user to select each message to read its content.

Rendering is the process of translating a set of instructions, code, or directives into a visual representation to be displayed on a specific device with characteristics such as size and aspect ratio. Email content is typically rendered “just in time” when it is selected to be read by a viewer.

In the descriptions and drawings that follow a small number of components and connections are sometimes shown to facilitate explanation and illustration. The number of components used herein is for example only. It should be understood that these examples do not describe the ultimate capability of the invention, including quantity of components, number of instances or interconnections that are possible. The embodiments disclosed below are not intended to be exhaustive or limit the invention to the precise form disclosed in the following detailed description. Rather, the embodiments are chosen and described so that others skilled in the art may utilize its teachings.

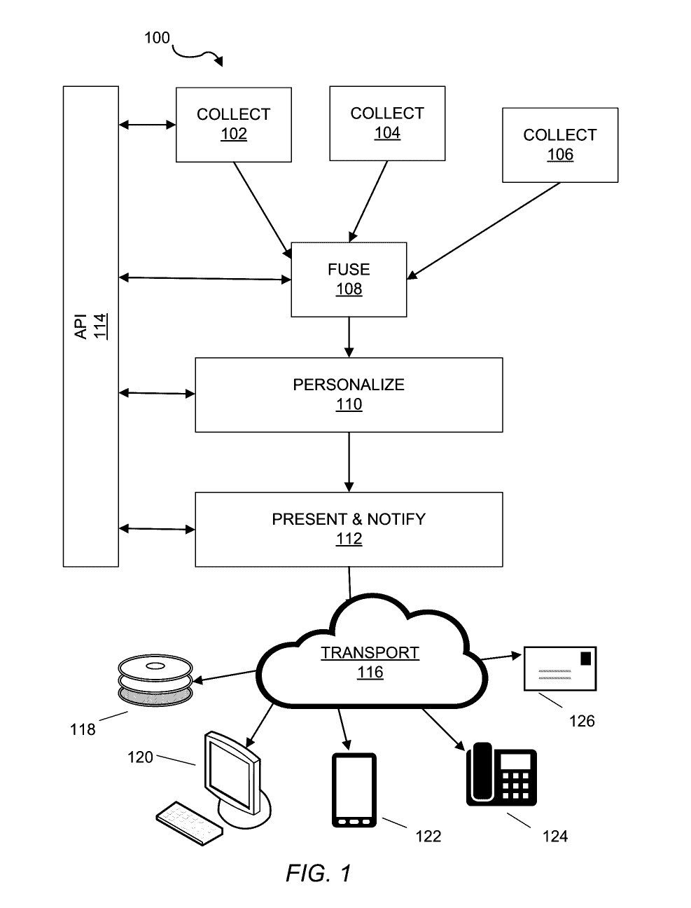

Referring now to the Figures, FIG. 1 is a high-level depiction of an architecture and operations according an embodiment of the descriptions herein. System 100 comprises an arrangement of components and sequence of operations to collect and process data related to delivery of multiple email messages. Data collection operations 102, 104 and 106, in various embodiments, comprise gathering information about aspects of email delivery including rates of delivery, assessment of sender reputation, percentage of messages rejected, messages tagged as SPAM, actually delivered, or unaccounted for. Data collection operations 102, 104 or 106 may also in some embodiments include feedback to the sender on the appearance of email on various platforms and devices. In some embodiments one or more of collection operations 102, 104, and 106 includes a periodically updated assessment of the reputation of the email sender. Fuse operation 108 combines the data from collection operations 102, 104 and 106 and presents the data after fusion to personalization layer 110. Personalization layer 110 applies rules and operations that may differ among users. In some embodiments, each user or email originator specifies rules and preferences that are applied by personalization layer 110 to configure the information presented and notifications delivered by presentation and notification layer 112.

Notifications are presented through transport 116, which in various embodiments comprises communication protocols and connections to send data to any of a variety of devices or endpoints. Transport 116 in various embodiments includes connections through local networks, wireless or other cellular and mobile data networks, the Internet, or any of a variety of voice or data communication links. For example, FIG. 1 shows as illustrative devices computer 120, cell phone 122 which may receive voice, email and text (SMS) messages, telephone 124, and email message 126. Also shown is storage device 118 for archiving, storage, and search of notifications and information presented.

FIG. 1 also shows Application Programming Interface (API) 114. In one embodiment API 114 provides a set of interfaces to components that may be used to create, control and combine execution and data from other system components.

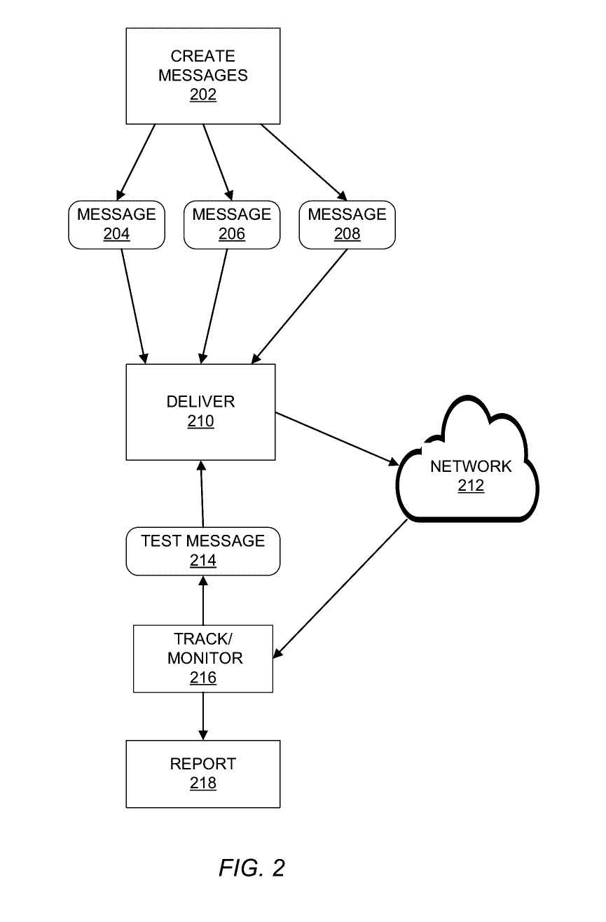

FIG. 2 illustrates a sequence and arrangement of operations according to an embodiment of the descriptions herein. Message creator 202 creates a plurality of email messages 204, 206, 208, each addressed to a different email address obtained from a list. Although three messages 204, 206, 208 are shown for simplicity of illustration, in some embodiments the number of messages is much larger, for example message creator 202 may comprise multiple computers or processors and create hundreds or thousands (or more) messages.

In one embodiment each of the messages 204, 206, and 208 contain custom code for each user. Thus message creator 202 generates custom content and embedded code. In another embodiment messages 204, 206, and 208 are identical except for different destination addresses.

An important aspect of email that distinguishes email from conventional printed mail is that email is rendered into final displayed form at the point of delivery rather than before sending. Essentially each email message contains a description and instructions that are used by the receiving system to generate the visual display which may include text, graphics, multi-media, hyperlinks, and other interactive content. The instructions are provided in the form of encoded text, hypertext markup language (HTML) code or various other schemes familiar to those skilled in the art.

This delayed rendering introduces challenges because not all rendering systems execute the instructions in the same manner and thus displayed content does not appear the same to every recipient. Conversely, the execution of instructions or code provides an opportunity to embed code that will be executed when each message is displayed.

Accordingly, in one embodiment messages 204, 206, and 208 are created with embedded code that facilitates tracking and monitoring. Messages 204, 206, and 208 are sent to users by delivery 210 using network 212. Tracking and monitoring code is executed when the message is displayed, causing instrumentation messages to be sent through network 212 to tracking and monitoring server 216.

In one embodiment tracking and monitoring server 216 creates a test message 214. Again, message 214 is shown as a single message for illustration but in some embodiments a plurality of different test messages are created and delivered. Test message 214 is not intended for delivery to any actual user but rather is created to track message delivery. Test message 214 may be configured for delivery to specific domains, regions, internet service providers (ISP) and return information to tracking and monitoring server 216.

Tracking and monitoring server 216 sends collected data and information to reporting 218 for storage or display.

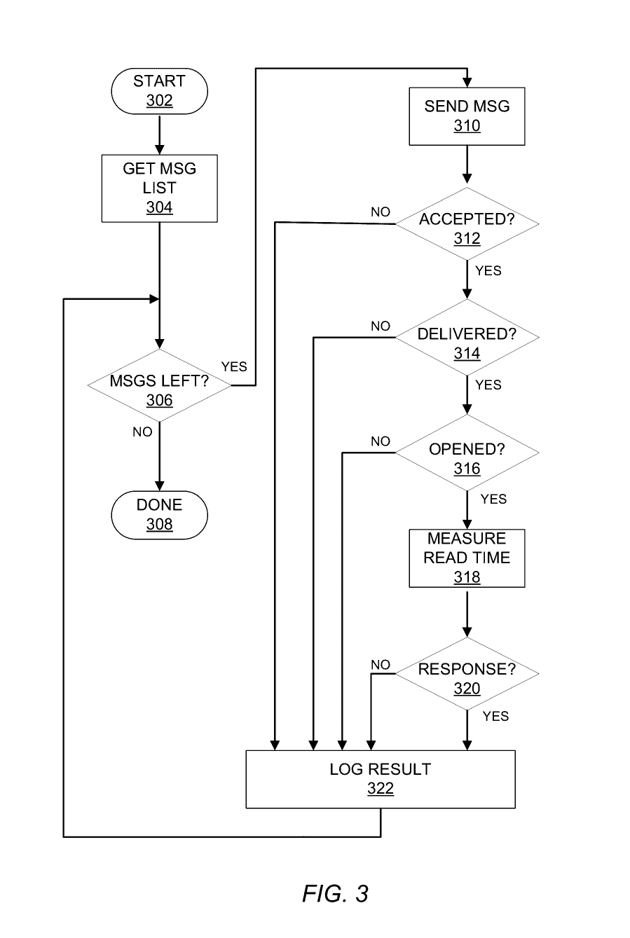

FIG. 3 depicts a flow chart according to an embodiment of the descriptions herein. Although the operations are shown as iterating through a list of messages one at a time, this is for ease of disclosure and it should be understood that many of the processes may be undertaken and multiple messages may be sent in parallel.

Commencing at block 302 and moving to block 304 the sending email server obtains a list of messages to be sent. At decision diamond 306 the sending server determines if there are messages that have not been sent, iterating through the list of messages. If it is determined at decision diamond 306 that no messages remain to send, processing of the list ends at termination 308.

On the other hand, if it is determined at decision diamond 306 that there are messages remaining in the list to send, processing continues at block 310 where the server sends the next message into the network 212. In one embodiment the time of transmission is recorded to use in subsequent time interval measurements.

At decision diamond 312 the message is sorted according to whether it was accepted or rejected by the email servers. At decision diamond 314 the message is sorted according to whether it was delivered to the recipient's inbox. At decision diamond 316 the message is sorted according to whether it is opened by the recipient. If opened, processing continues at block 318 where the time spent looking at the opened email is determined. In some cases, an email requests a response or transaction, and at decision diamond 320 the message is sorted according whether the recipient responded. In all cases, the results of the sorting operations are logged at block 322 and processing continues to decision diamond 306. When decision diamond 306 determines no messages remain to be processed, execution terminates at 308.

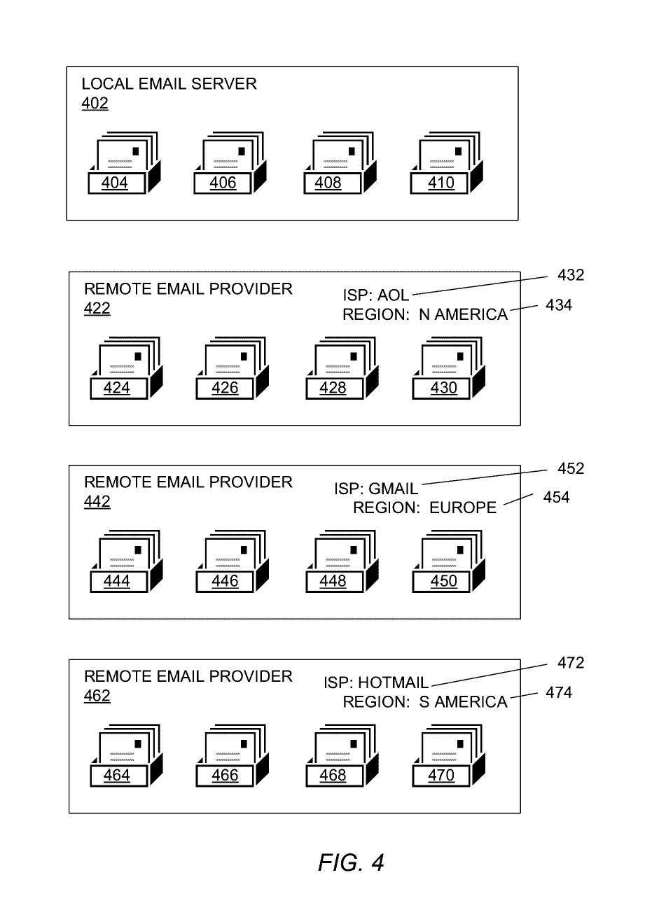

FIG. 4 illustrates a configuration of email servers according to an embodiment according to the descriptions herein. In one embodiment a sender of mass email campaigns is provided with a plurality of test mail destination addresses to include with the list of actual target users for each campaign. These addresses are sometimes referred to as a “seedlist.” The test email destination addresses correspond to actual mailboxes that are monitored for messages delivered. Accordingly, in one embodiment multiple test mail addresses or mailboxes are preconfigured to be available to include in seedlists. These mailboxes are strategically created in selected destinations to have characteristics useful in monitoring mass email delivery. For example, in some embodiments the test email inboxes are created to correspond to span a set of ISPs and geographical locations. In one embodiment the test email inboxes are created on destination sites that may be categorized as business to business (B2B) or business to consumer (B2C) destinations.

Accordingly with reference to FIG. 4, in one embodiment four test email inboxes 404, 406, 408, and 410 are created on local server 402. Mailboxes 404, 406, 408, and 410 provide destination addresses for email messages. Because local email server 402 is controlled by the testing organization, it provides a baseline test case where the configuration of server 402 is completely known and stable.

However it is advantageous to also configure mailboxes on remote servers, and in one embodiment these mailboxes are created in the same manner as an actual user mailbox. In FIG. 4, mailboxes 424, 426, 428, and 430 are created at remote mail provider 422. Mailboxes 424, 426, 428 and 430 appear to email provider 422 to be typical users so are useful in monitoring message delivery. The test mailboxes will experience any delay, throttling, filtering or content monitoring that email provider 422 applies to message delivery to actual users. It may be seen that email provider 422 is known to correspond to Specific ISP A 432 and be located in North American region 434 and may thus be used to provide instrumentation data on email delivery corresponding to this region and ISP.

Similarly four mailboxes 444, 446, 448, and 450 are created with email provider 442 in region 454 of Europe with ISP 453. Four mailboxes 464, 466, 468, and 470 are set up with email provider 462 in the region 474 of South America with ISP 472.

It should be appreciated that the number of email target destinations created and the number of email providers, destinations, regions, and ISPs are not limited to the number illustrated but rather are selected to provide a suitable variety of parameter variation, desired tracking granularity, and avoid sending too many messages to any one mailbox which could cause the provider to treat it differently than a typical user mailbox.

It should be further appreciated that a seedlist of addresses need not contain every preconfigured target mailbox address. Rather, it is a feature of embodiments of the present invention that each seedlist is generated to contain a selected and tailored subset of the test mailboxes available.

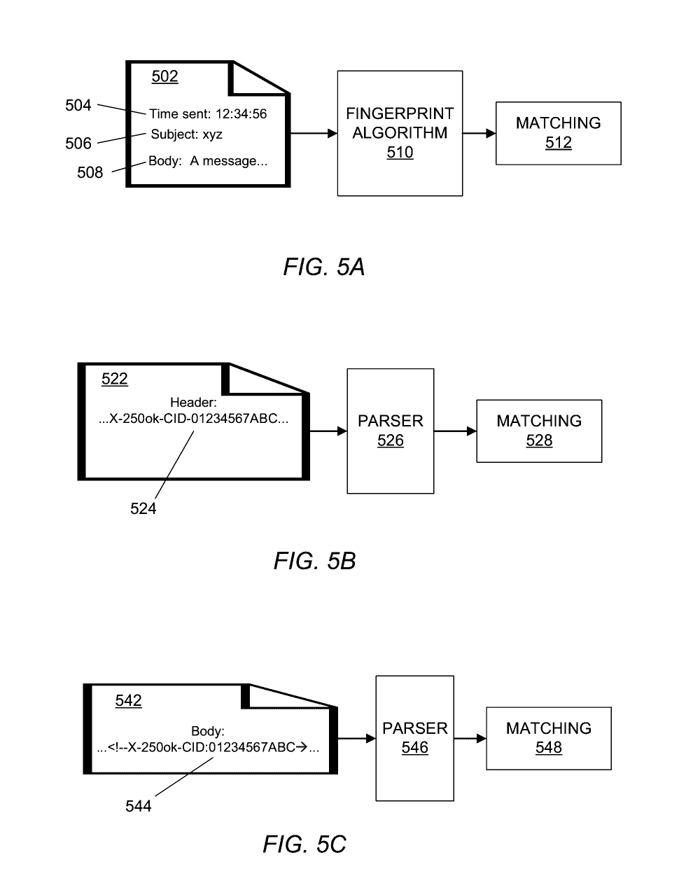

FIGS. 5A, 5B, and 5C schematically depict techniques for matching incoming messages according to embodiments of the features and descriptions herein. The test mailboxes described in connection with FIG. 4 are in one embodiment shared by multiple senders and by multiple campaigns by the same sender. Thus an embodiment of the features and descriptions herein includes a technique for processing received email messages to match each message with a sender and a campaign so that each campaign may be tracked.

Accordingly in FIG. 5A algorithm 510 computes a fingerprint of message 502 based on time sent 504, subject text 506, and message body 508. The fingerprint computed by algorithm 510 is unique to the specific content and is used by matching 512 to correlate the received message 502 with an existing campaign. In many situations, fingerprint algorithm 510 is sufficient to match messages and facilitate tracking and monitoring.

In other situations it is desirable to provide a custom campaign identifier explicitly. FIG. 5B illustrates a technique for providing an explicit campaign identifier according to an embodiment. Message 522 contains as part of its header, identifier 524. Identifier 524 is inserted into the header of message 522 prior to sending. Identifier 524 begins with a predetermined character string, in the illustrated case the string is “X-250ok-CID.” Identifier 524 also contains a campaign ID string, in this case “01234567ABC.” Parser 526 extracts identifier 524 and the corresponding campaign ID. Matching 528 correlates the campaign ID with an existing campaign.

It is not always possible or desirable to alter message header code. In FIG. 5C an alternative technique is illustrated according to an embodiment. Message 542 contains a snippet of embedded HTML code 544 that contains a campaign ID that is extracted by parser 546 and matched with a campaign by matching 548.

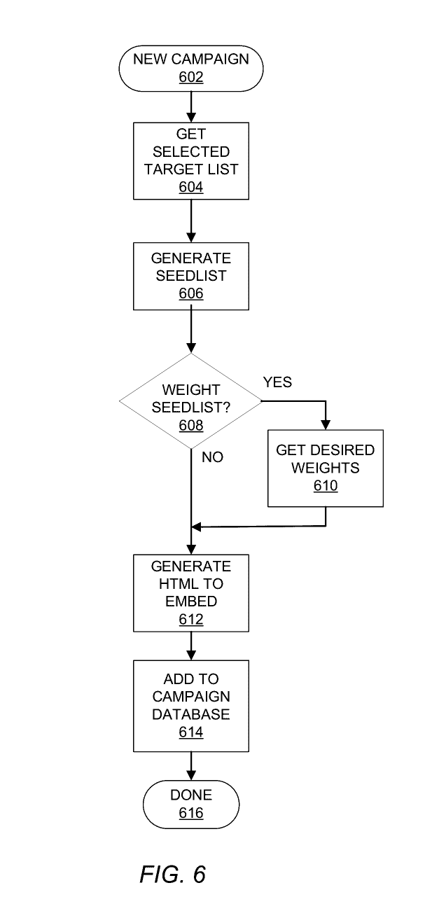

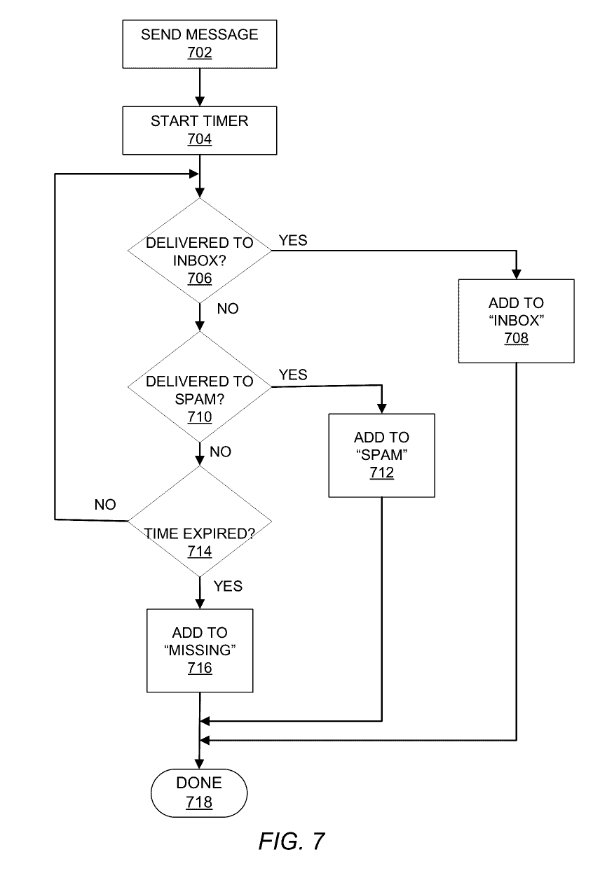

FIG. 6 depicts a flow chart according to the descriptions herein for initiating a new email campaign. The process starts at block 602. Next, at block 604 the computer gets a list of selected target email addresses that are to be used in the new campaign. Proceeding to block 606 the email target list is used to generate a seedlist of test email addresses that are then included in the campaign email target list.

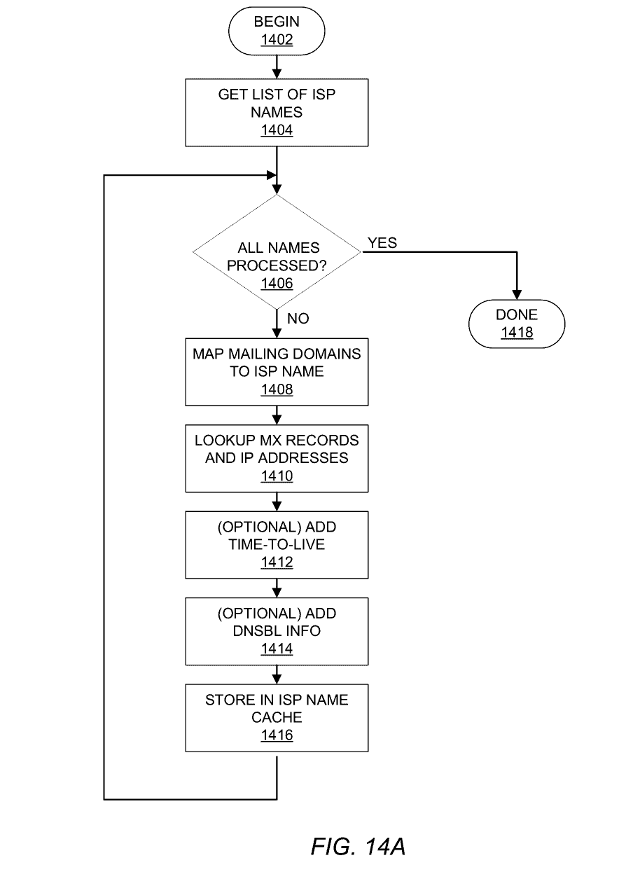

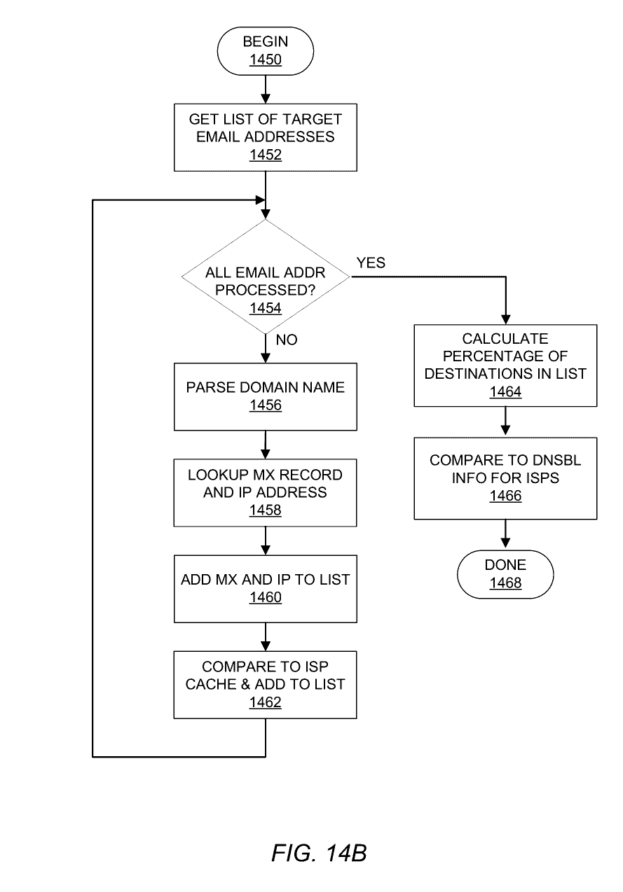

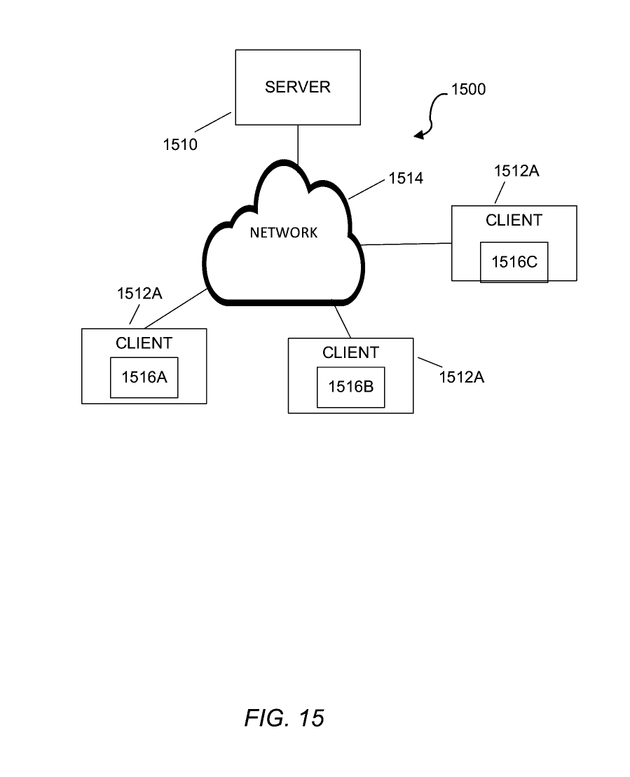

The generation of a seedlist is described further in connection with the description of FIG. 4. At decision diamond 608 the user is asked to choose whether the seedlist should be weighted. If the user selects yes the computer weights the seedlist. In one embodiment the weighting is based on the distribution of ISPs in the target email list. In one embodiment the weighting is based on the geographical IP addresses. Other weighting schemes are possible in accordance with the teachings herein. The process of determining weights is further described in connection with FIGS. 14A and 14B.

In either case, processing proceeds at block 612. At block 612 the computer generates a snippet of HTML code to be embedded in the body of each email sent out. This code will be executed as part of the process of rendering the message for display to the end user and may accomplish a variety of purposes. In one embodiment, the generated code implements a “beacon” or single pixel graphic.

This causes the rendering computer to send a specific request to a server for a graphic file, and the request contains a message encoded to provide information to the server about the rendering computer at the message destination. This information may include for example, the time the message is opened, the type of browser and device used to view the message, and this information may be used to collect aggregate statistics about the email campaign.

Processing proceeds at block 614 where the computer generates and stores tags that may be used to associate the email messages with the campaign. Embodiments according to this are further detailed in the descriptions accompanying FIGS. 5A, 5B, and 5C. Processing terminates at endpoint 616.

FIG. 7 depicts an additional flow chart according to an embodiment of the descriptions herein. Processing begins with a server sending a message at block 702 and proceeds to starting a timer at block 704. Typically, this process is performed for many messages and statistics collected result from processing a large number of individual messages.

At decision diamonds 706, 710, and 714, the sent message is categorized into one of three outcomes. If a confirmation of delivery has been received decision diamond 706 results in taking the path to block 708 where the inbox counter is incremented and the process ends with terminator 718. If a SPAM report is received, decision diamond 710 is affirmative and results in taking the path to block 712 where the SPAM counter is incremented and the process ends with terminator 718.

If the timer initiated at block 704 reaches a preset threshold value, decision block 714 is affirmative and processing proceeds at block 716 and the missing timer is incremented and the flow ends at terminator 718. Decision diamonds 706, 710 and 714 are repeatedly applied in a processing loop until one of the three tests applied is affirmatively satisfied.

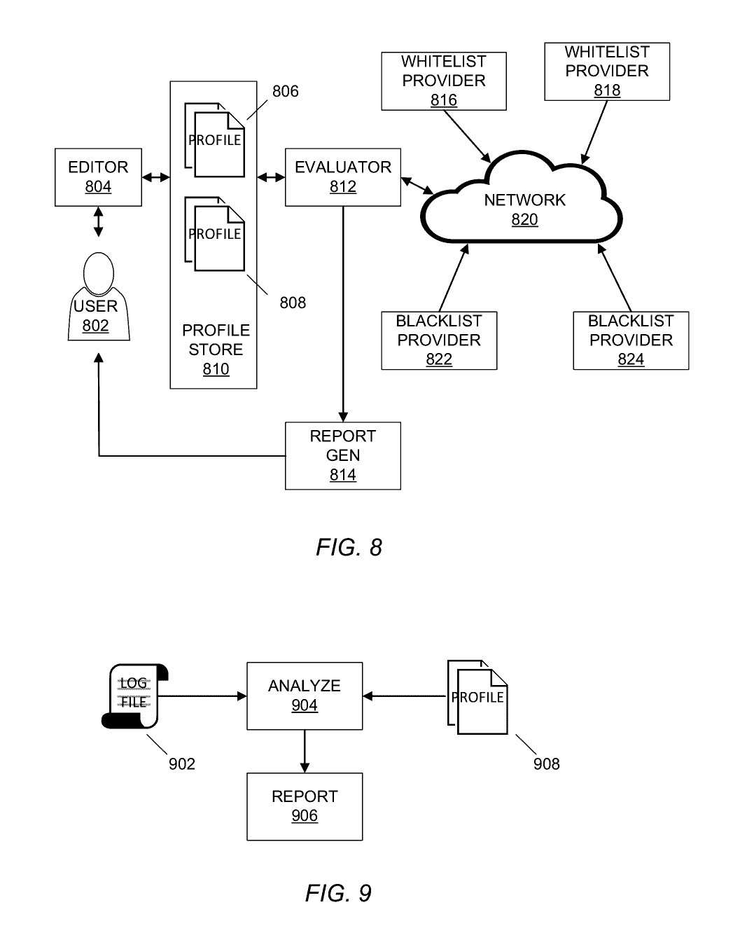

FIG. 8 depicts an arrangement of components and operations to implement an embodiment of the descriptions herein. User 802 is an initiator of an email campaign desiring to assess the reputation of the sender and periodically to update the reputation by querying various servers that label domains and IP addresses as sources of SPAM or other unwelcome email messages, and additionally query servers that provide authentication of valid sent email and credentials. In one embodiment user 802 uses editor 804 to create and update profiles in profile storage 810, including profile 806 and profile 808. Profile 806 and 808 contain lists of email sources and evaluations to be performed, as well as information indicating when the evaluation is to be updated. Evaluator 812 applies profile 806 and 808 in profile store 810 when each profile indicates it is scheduled to be updated.

According to one embodiment evaluator 812 retrieves a list of desired reputation providers from profile 806 or profile 808 when each is scheduled to be updated. Evaluator 812 queries reputation providers selected through network 820, for example queries may be sent and responses received from whitelist providers 816 and 818 and blacklist providers 822 and 824. The result and responses received from queried providers are stored and displayed by report generator 814. Blacklist providers 822 and 824 maintain an evolving list of sites suspected of sending SPAM email messages. The sites may be cataloged and referenced by IP address, domain name, or other identifiable characteristic of a site that identified incoming email messages.

The term reputation, as applied to a site and electronic messaging is defined as the confidence (or lack thereof) that messages from the site will be welcome by users, rather than annoying or malicious. Reputation is assessed typically by past behavior.

FIG. 9 further depicts an arrangement of components according to an embodiment of the descriptions herein. Email analyzer 904 ingests email logfile 902 and profile 908 and in various embodiments applies techniques to gather information corresponding to email campaigns, SPAM rejections, and reputation indicators. Results from analyzer 904 are collected, saved and displayed by report generator 906.

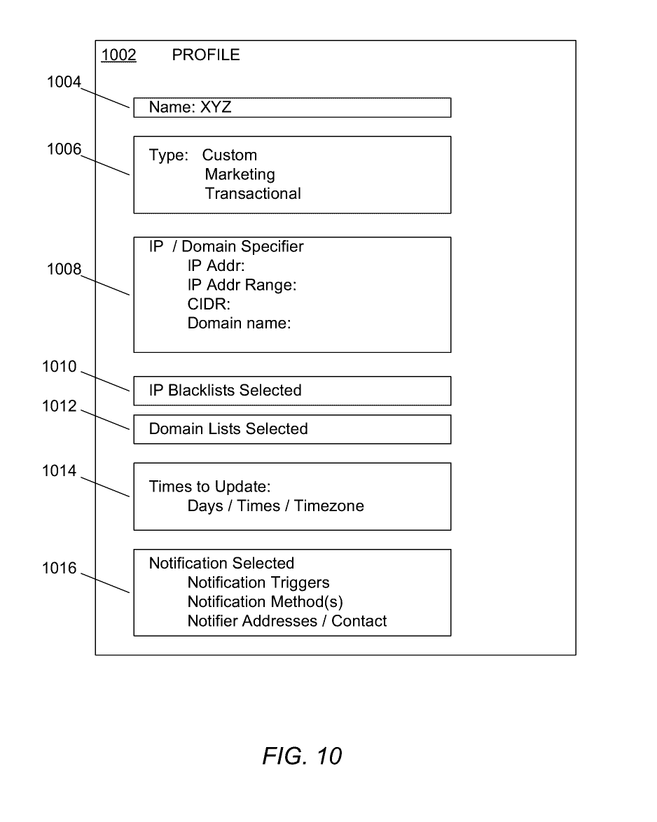

FIG. 10 illustrates an embodiment of a data structure according to the descriptions herein. Data structure 1002 is configured to store information used to assess the reputation of an email sender. In one embodiment, profile structure 1002 corresponds to profile 806 and 808 previously described. Profile structure 1002 contains several fields. Name field 1004 contains the name of the profile assigned by a user. Type field 1006 contains the type of the profile. In one embodiment the possible values in type field 1006 are “custom,” “marketing,” and “transactional.” Field 108 contains the address specifier of the profile. Addresses may, in various embodiments, be specified as a single IP address, a range of IP addresses, a classless Internet domain record (CIDR), or one or more domain names.

Field 1010 stores the selected IP blacklists to query and field 1012 stores selected domain lists to query. Schedule field 1014 specifies the times of day, days of week, and timezone to update the reputation by querying selected lists in field 1010 and field 1012.

Notification field 1016 specifies events that trigger notifications and the desired notification action to be taken when the even occurs.

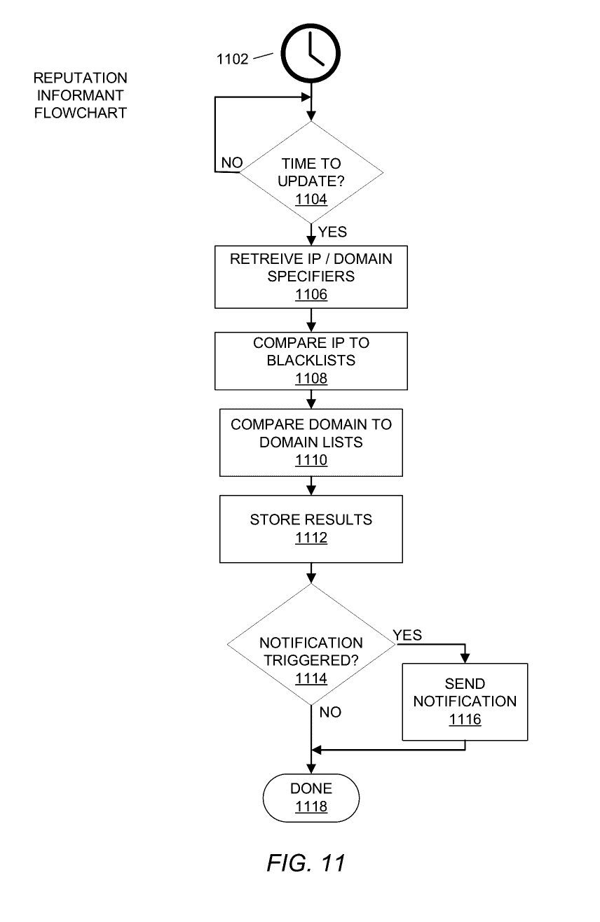

FIG. 11 depicts a flow chart according to embodiments described herein for updating a reputation impression. Starting at timer 1102 in conjunction with decision diamond 1104 a processor waits for the scheduled update time to arrive. When the time arrives, decision diamond 1104 proceeds to block 1106. At block 1106 the server obtains a list of IP and domain specifiers to be used to query reputation providers. Processing proceeds at block 1108 where the specifiers are used to query reputation providers against IP blacklists. Processing proceeds further at block 1110 which causes a server to query domain lists with the specifiers.

Results are stored or updated at block 1112. At decision diamond 1114 the results are compared against specified notification events, and if the comparison yields a match, processing proceeds at block 1116, sending the selected notification corresponding to the trigger event. If there is no match, processing proceeds to termination 1118. In either case, processing of the reputation update terminates at 1118.

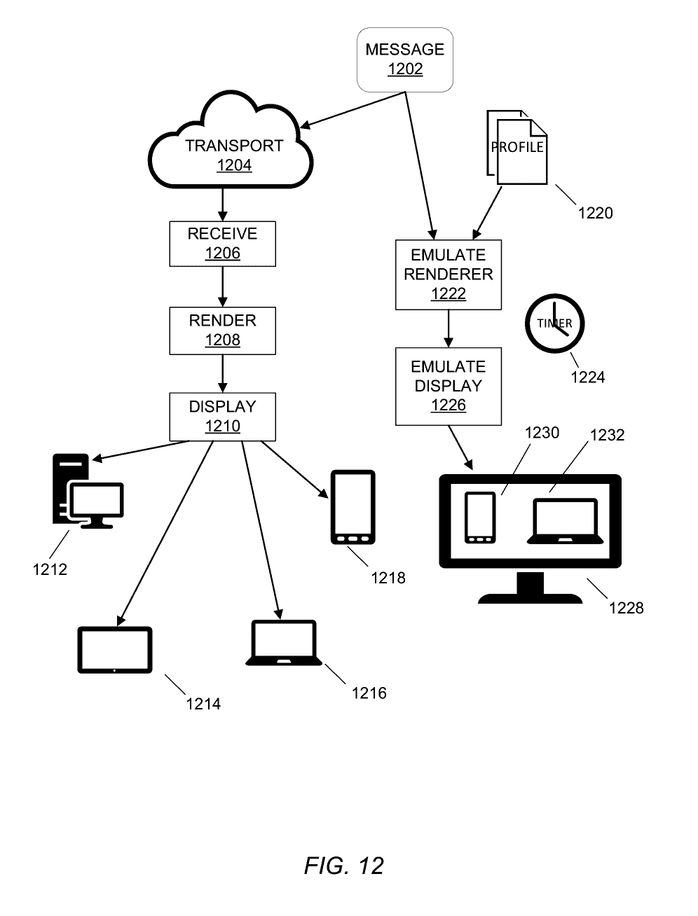

FIG. 12 shows an arrangement and sequence of operations implementing the features and descriptions described herein. Email differs from print mail in that what is transmitted is not the final visual image, but instead a description or instructions used to generate the visual display. The email may include instructions to create text in various fonts, colors and styles, implement processes, retrieve additional media objects, make decisions, or obtain user input. A difficulty arises because the sender cannot control all of the possible systems, processors, and configurations of devices used to render and present data, and those familiar with the art will understand that the end result displayed to a user may vary widely in quality, aesthetic appeal, correspondence with the intended design, and even readability. Thus email generators may spend considerable time and effort in creating email that is displayed well on multiple devices and using varying operating systems and rendering software. According to one embodiment of the descriptions herein, a sender's email list may be used in conjunction with embedded HTML code to determine the types of devices and rendering used by the majority of the users, and this enables an email sender to weight the types of devices encountered and concentrate resources on providing the best impression to the most recipients.

Referring to FIG. 12, message 1202 is sent via transport 1204 and received at server 1206. Renderer 1208 then translates the coded email into a visual display 1210, which may be presented on one or more devices. For example desktop computer 1212, tablet computer 1214, laptop computer 1216, and mobile telephone 1218 may be used to view the rendered message 1202. These devices differ in display size, aspect ratio, resolution, memory, computing power, and other aspects, all affecting the visual display presented.

Still referring to FIG. 12, an embodiment of the descriptions is depicted enabling the sender of an email to view a visual representation of an email as presented on various devices. Message 1202 is processed by render emulator 1222 and display emulator 1226 to display virtual representations of various devices. For example, computer display 1228 is depicted as displaying virtual representations of a display on mobile phone 1230 and laptop computer 1232.

These virtual representations may be configured to emulate various specific models of devices, operating systems, browsers, renderers, and the like. In one embodiment, profile 1220 contains a weighted list of devices that have been used to view previously sent emails from a user, and this data may be used to ensure that visual rendering code performs best on the most frequently encountered viewing platforms. In one embodiment, timer 1224 records the time required to render message 1202 on differing platforms, allowing further adjustment to ensure that rendering is configured to be faster on the most frequently encountered rendering and display platforms.

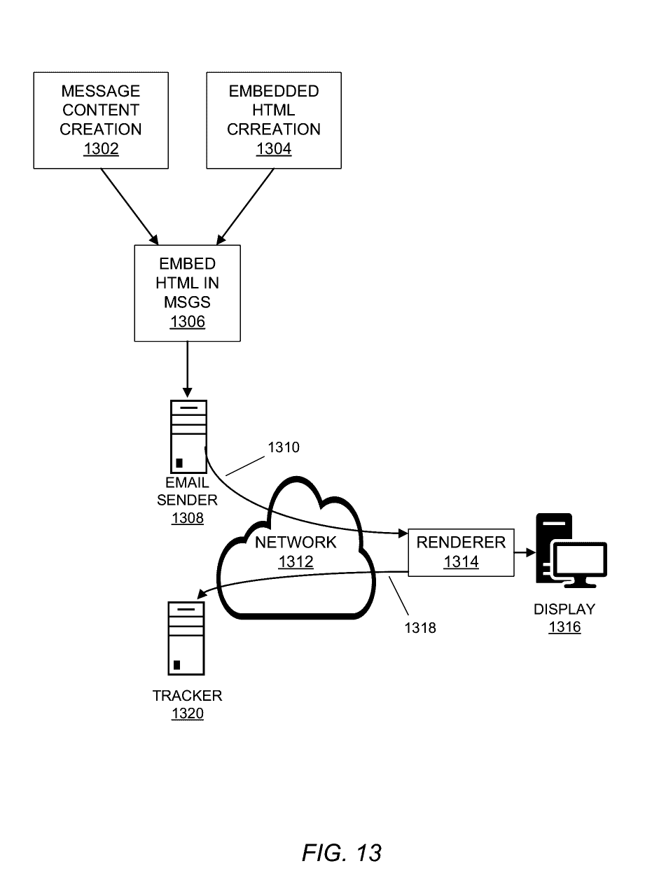

FIG. 13 schematically depicts an arrangement of components according to an embodiment of the descriptions herein used to insert and apply code to perform email tracking and obtain feedback information. Conventional message content generator 1302 creates a conventional email message. In one embodiment, embedded code generator 1304 generates a snippet of code.

In one embodiment the code inserted is a short piece of HTML code that causes the renderer 1314 to send information in a message to tracker 1320. Merger 1306 embeds the code from code generator 1304 into the message from message generator 1302, and the merged message is sent using email sender 1308 via path 1310 through network 1312. The intended destination includes renderer 1314 that translates the coded email into a visual representation viewable on display 1316. However as part of the rendering process, the rendered encounters and executes the code from code generator 1304. This code causes message 1318 to be sent to tracker 1320 via network 1312. In one embodiment message 1318 confirms delivery of the email to a viewer. In some embodiments, message 1318 provides the time of delivery, information about the rendering platform, viewing device, operating system and version, and time spent reading the email. As has been discussed herein, obtaining feedback of this type is useful to the originator of the email in many ways and provides reporting of delivery device statistics.

FIGS. 14A and 14B depict flow charts according to an embodiment of the descriptions herein for mapping among lists of addresses, IP addresses and ISPs. Beginning at entry 1402, processing continues to block 1404. At block 1404 the executing processor obtains a list of ISP names that may be tracked. Proceeding to decision diamond 1406, diamond 1406 causes processor to iterate through each of the items in the ISP list, applying the subsequently described processing to each. When all names have been processed, decision diamond 1406 is affirmative and processing continues to termination 1418. The ISP mapping is completed and the data is cached.

For each item in the ISP list processing continues at block 1408. At block 1408 each ISP is mapped to a mailing domain. Processing continues at block 1410 where MX records and IP addresses are obtained by DNS lookup for each mailing domain. In some embodiments an optional time to live is obtained at block 1412. In some embodiments the time to live corresponds to the TTL value for the DNS MX record.

In one embodiment DNSBL info is added to the cached info at block 1414. Finally processing proceeds in block 1416 with storage of all gathered information in a data cache for subsequent use.

FIG. 14B shows how the information cached as detailed in conjunction with FIG. 14A may be applied. Processing begins at entry 1450 and proceeds at block 1452 with obtaining a list of target addresses. In one embodiment the target list is a list of email addresses that are intended recipients of email messages in a campaign, a customer email target list. Decision diamond 1454 provides an iterator to apply the operations to follow to each item in the list of target email addresses. When items remain to be processed in the target email list, decision diamond 1454 is false and processing continues at block 1456. At block 1456 the email address is parsed to extract the domain name. Proceeding to block 1458, at block 1458 the processor performs a lookup of the MX record and IP address corresponding to the parsed domain name. At block 1460 the MX and IP data are added to the list being collected corresponding to the email addresses. Next, at block 1462 the data obtained for the email address is matched and compared against the cached data obtained as described in connection with FIG. 14A. Processing then returns to decision diamond 1454, Decision diamond 1454 is applied to determine if there are items left to process. When all items are processed decision diamond 1454 is yes and processing continues with block 1464. Block 1464 analyzes the list of items and weights them according to the number of times an item appears in the list. Next at block 1466 the list items are compared against any DNS blacklist (DNSBL) information available. Typically this may be used to provide to an email sender specific advice based on the actual email addresses used, of the effect on their email deliverability of being blacklisted by any one ISP. Processing terminates at 1468.

Additional embodiments of the invention may include seed list optimization routines. For example, The core of seedlist optimization is analysis of a user-provided list of recipient email addresses having the form mailbox@hostname. Where hostname is of the standard format for internet hosts, e.g. google.com, alerts.250ok.com, etc.

With this in mind, analysis proceeds as in the following pseudocode:

for each address

parse hostname

if hostname is unique

create hostname record, and

set hostname_count to 1

else if hostname_alias exists

using hostname_alias, increment hostname_count by 1

else increment hostname_count by 1

count hostname records, and
store result in unique_hostnames
for each hostname

compute (hostname_count / unique_hostnames * 100), and

store result in hostname_weight

The definition of “unique” bears particular consideration in this context. As previously mentioned, it is common for recipient domains to use commoditized infrastructure. In the above pseudocode, the term hostname_alias refers to a “virtual” hostname that represents the underlying infrastructure powering many different recipient domains. To ensure proper weighting, the counts for all such domains are aggregated against the hostname identified by hostname_alias instead of the hostname parsed from the user's recipient list entry.

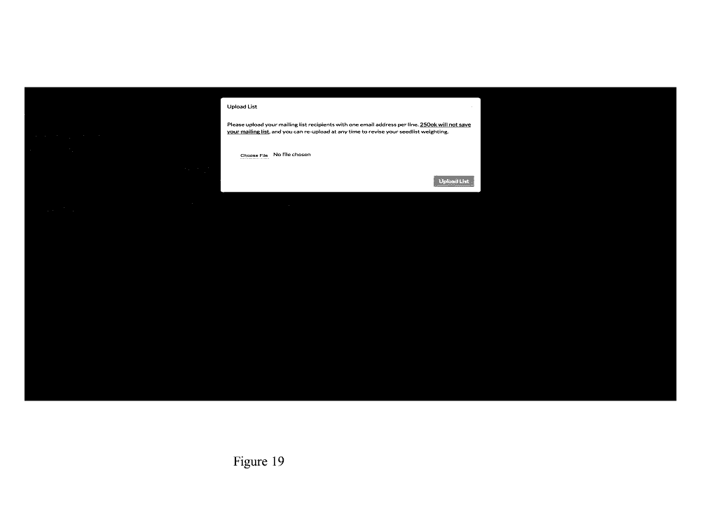

Seedlist Optimization begins with Get Seedlist function within Inbox Informant. The first step is retrieving seedlist addresses in the normal fashion. Optimization is initiated by clicking the Optimize List button, see FIG. 17. We next request a list of recipient email addresses that will be used to generate a unique seedlist weighting tailored to that specific recipient list.

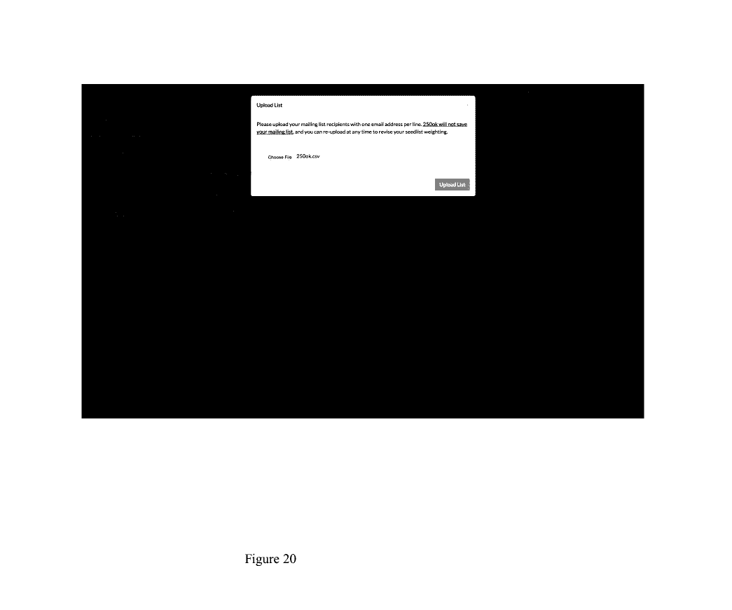

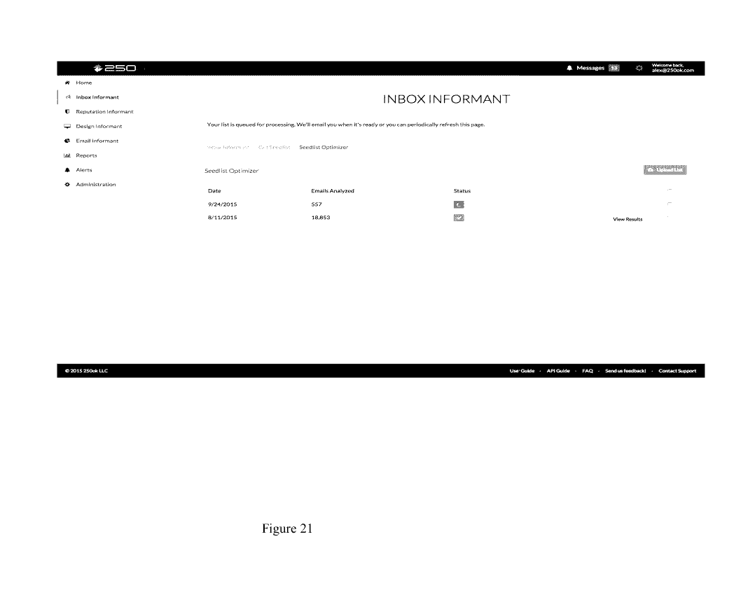

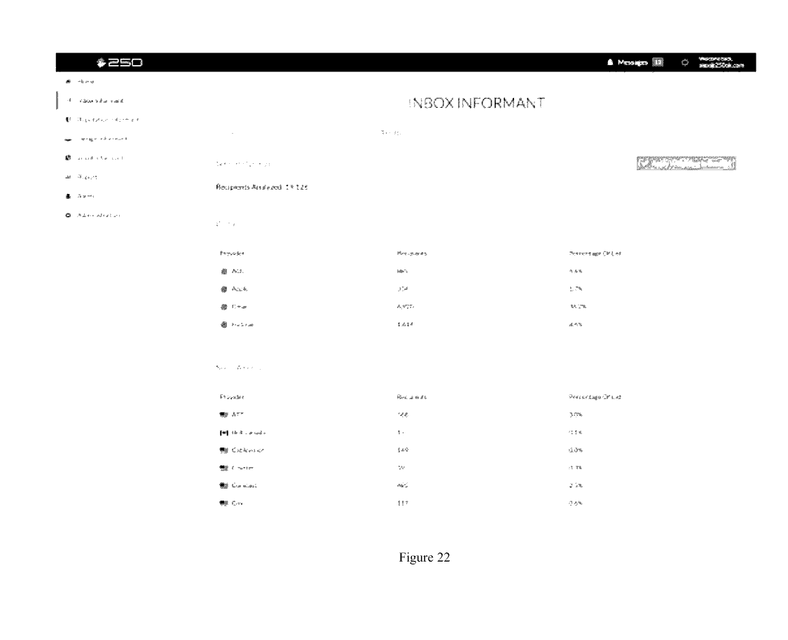

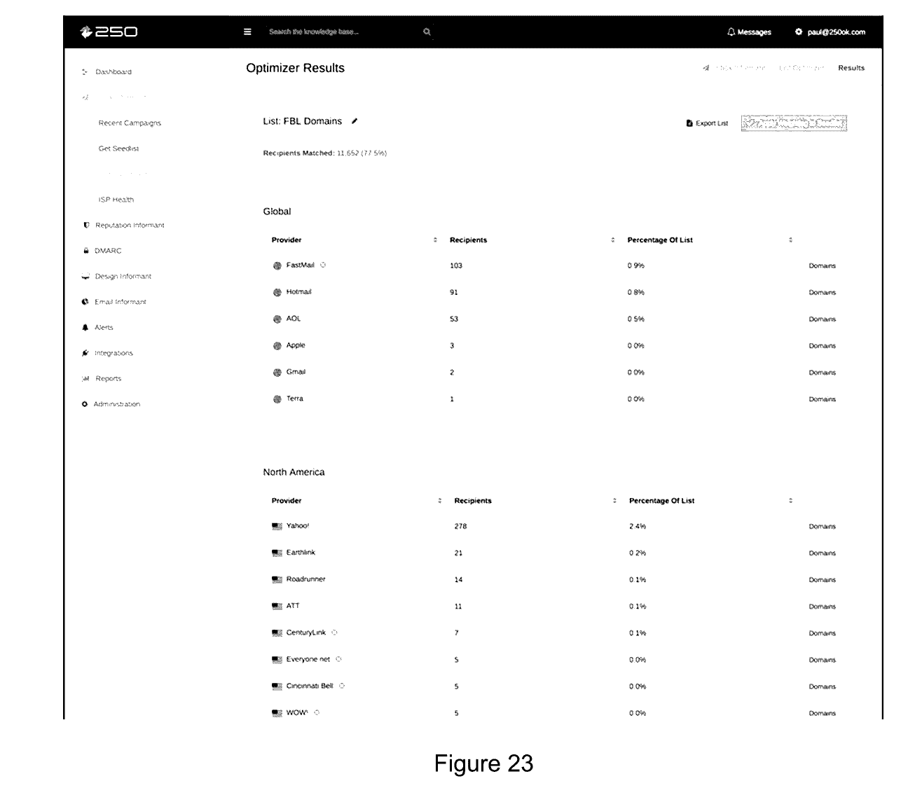

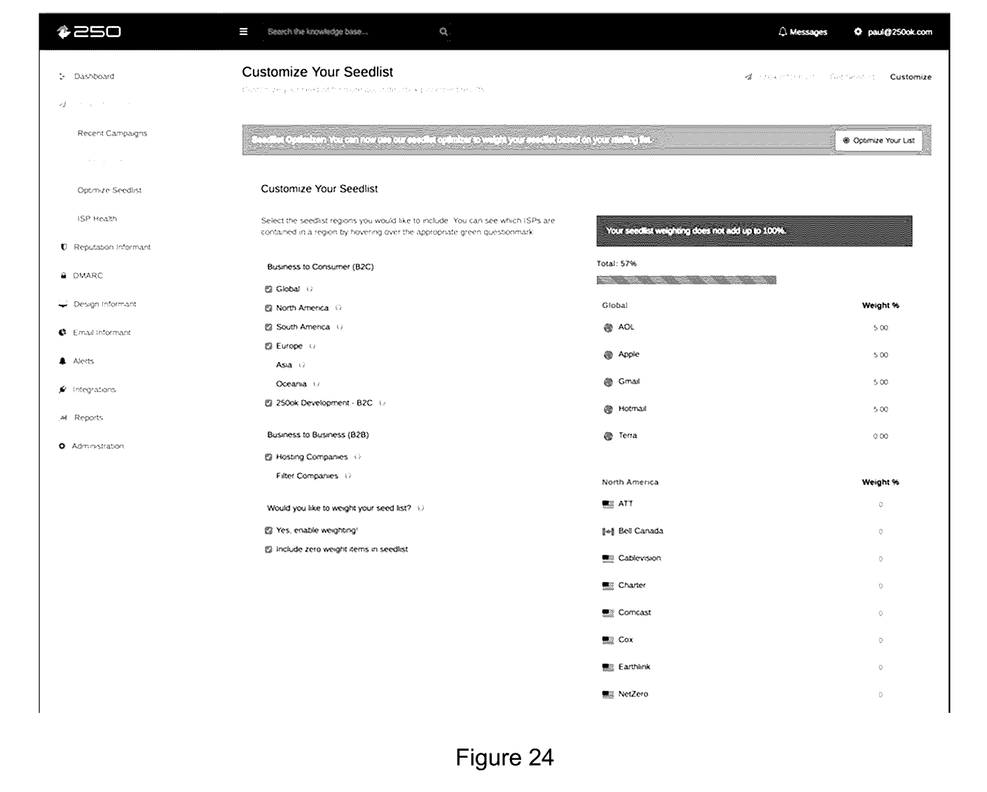

First, the user invokes the Upload List dialog through the Seedlist Optimizer UI as shown in FIG. 18. A dialog is presented allowing the user to select from the files on their machine, or servers or file sharing services connected to their machine (e.g. Dropbox, departmental file servers, attached storage, removable storage, etc.), as shown in FIG. 19. Finally, the user confirms their selection by clicking the Upload List button as shown in FIG. 20. The user is then returned to the Seedlist Optimizer UI and can monitor progress of their list as analyzed, as shown in FIG. 22.

Via the View Results button the user may see the outcome of list analysis, which is a list of weights mapped to providers and organized into semantic groups such as by geographic region (e.g. North America, Asia), industry function (e.g. Hosting, Filtering), and other categories as may be appropriate.

The user may then choose to apply all or a subset of the weighting information to their seedlist.

Future releases of the List Analyzer will enable list processing functions that help refine the user's recipient list itself, as opposed to just fine-tuning seedlist test results. In other embodiments of the invention, further functionality includes that which removes known-bad addresses, non-deliverable domains, and other addresses that, should they be included in a campaign, all of which might negatively affect the user's sending reputation and cause decreased deliverability.

FIG. 15 is a high-level block diagram of a computing environment 1500 according to one embodiment. FIG. 15 illustrates server 1510 and three clients 1512 connected by network 1514. Only three clients 1512 are shown in FIG. 15 in order to simplify and clarify the description. Embodiments of the computing environment 1500 may have thousands or millions of clients 1512 connected to network 1514, for example the Internet. Users (not shown) may operate software 1516 on one of clients 1512 to both send and receive messages network 1514 via server 1510 and its associated communications equipment and software (not shown).

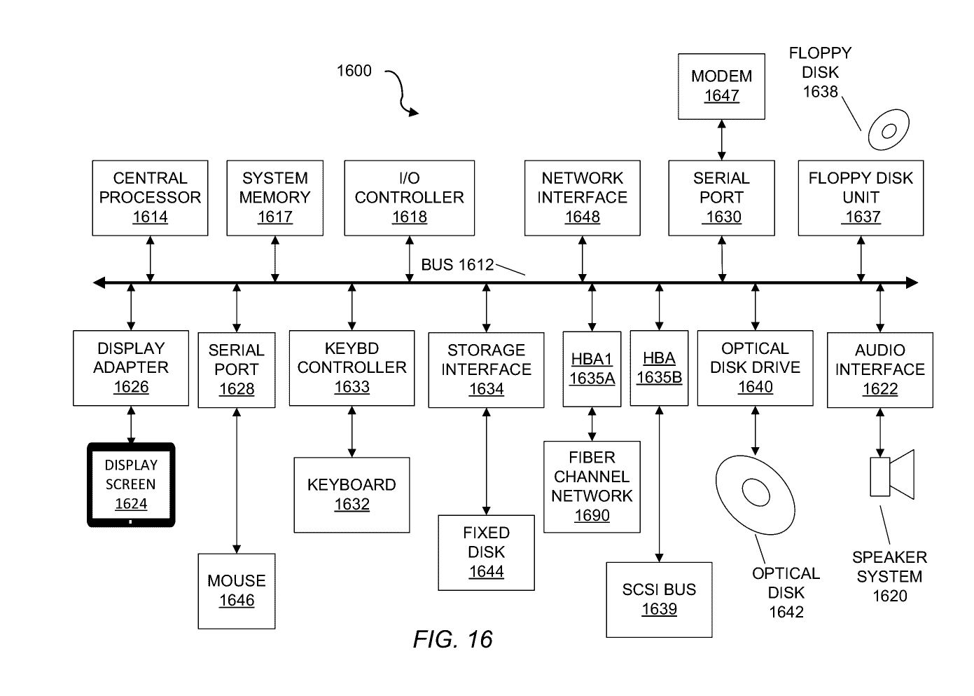

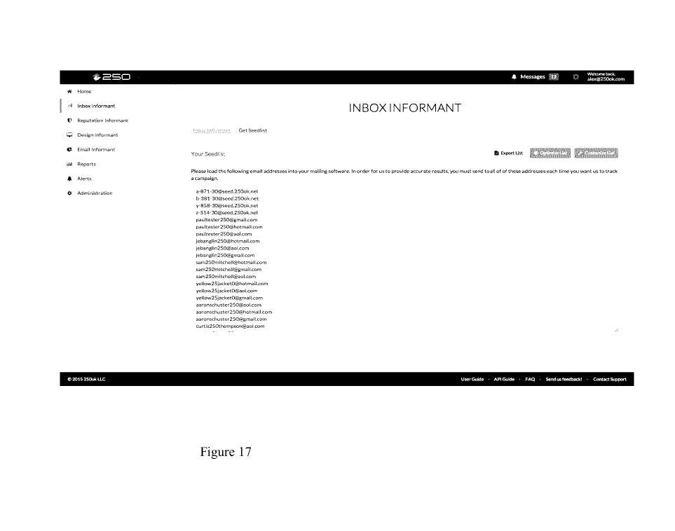

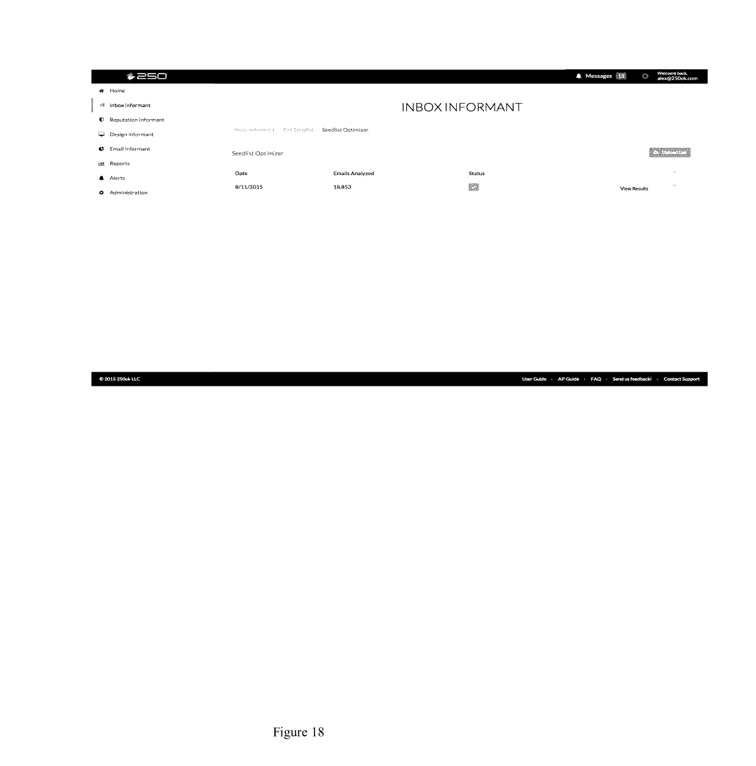

FIG. 16 depicts a block diagram of computer system 1600 suitable for implementing server 1510 or client 1512. Computer system 1600 includes bus 1612 which interconnects major subsystems of computer system 1600, such as central processor 1614, system memory 1617 (typically RAM, but which may also include ROM, flash RAM, or the like), input/output controller 1618, external audio device, such as speaker system 220 via audio output interface 1622, external device, such as display screen 1624 via display adapter 1626, serial ports 1628 and 1630, keyboard 1632 (interfaced with keyboard controller 1633), storage interface 1634, disk drive 1637 operative to receive floppy disk 1638, host bus adapter (HBA) interface card 1635A operative to connect with Fiber Channel network 1690, host bus adapter (HBA) interface card 1635B operative to connect to SCSI bus 1639, and optical disk drive 1640 operative to receive optical disk 1642. Also included are mouse 1646 (or other point-and-click device, coupled to bus 1612 via serial port 1628), modem 1647 (coupled to bus 1612 via serial port 1630), and network interface 1648 (coupled directly to bus 1612).

Bus 1612 allows data communication between central processor 1614 and system memory 1617, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 1610 are generally stored on and accessed via computer readable media, such as hard disk drives (e.g., fixed disk 1644), optical drives (e.g., optical drive 1640), floppy disk unit 1637, or other storage medium (for example memory sticks or flash drives). Additionally, applications may be in the form of electronic signals modulated in accordance with the application and data communication technology when accessed via network modem 1647 or interface 1648 or other telecommunications equipment (not shown).

Storage interface 1634, as with other storage interfaces of computer system 1610, may connect to standard computer readable media for storage and/or retrieval of information, such as fixed disk drive 1644. Fixed disk drive 1644 may be part of computer system 1610 or may be separate and accessed through other interface systems. Modem 1647 may provide direct connection to remote servers via telephone link or the Internet via an internet service provider (ISP) (not shown). Network interface 1648 may provide direct connection to remote servers via direct network link to the Internet via a POP (point of presence). Network interface 1648 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 16 need not be present to practice the present disclosure. Devices and subsystems may be interconnected in different ways from that shown in FIG. 16. Operation of a computer system such as that shown in FIG. 16 is readily known in the art and is not discussed in detail in this application. Software source and/or object codes to implement the present disclosure may be stored in computer-readable storage media such as one or more of system memory 1617, fixed disk 1644, optical disk 1642, or floppy disk 1638. The operating system provided on computer system 1610 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system. In some embodiments, computer system 1610 may take the form of a tablet computer, typically in the form of a large display screen operated by touching the screen. In tablet computer alternative embodiments, the operating system may be iOS® (iOS is a registered trademark of Cisco Systems, Inc. of San Jose, Calif., used under license by Apple Corporation of Cupertino, Calif.), Android® (Android is a trademark of Google Inc. of Mountain View, Calif.), Blackberry® Tablet OS (Blackberry is a registered trademark of Research In Motion of Waterloo, Ontario, Canada), webOS (webOS is a trademark of Hewlett-Packard Development Company, L.P. of Texas), and/or other suitable tablet operating systems.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

Computer system 1600 may be include any subset or all of the components described herein, and may also include more than one instance of some components. The components, quantities and properties of components selected to create computer system 1600 are selected such that computer system 1600 is suited for a set of desirable properties. For example if computer system 1610 may, in various instances be a server, a desktop, a laptop, a portable device (such as a tablet) or a smartphone. A server, for example is designed to have a large quantity of reliable data storage such as optical disk drive 1640 and high speed network interfaces 1635A. A desktop is designed to have a large display 1624 and keyboard 1632. A laptop is designed to be portable and includes a battery (not shown).

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

I claim:

1-2. (canceled)

3. A system for providing optimized email campaign seed lists from tracking and monitoring email campaigns over a network, comprising:
a server operating a seed list optimizer, the server adapted to communicate with and over the network, wherein the server is further configured to:
receive and store at least one seed email address on at least one email server in an email database;
receive and store at least one campaign in a campaign database, wherein the at least one seed email address is associated with the at least one campaign;
send at least one email to the at least one seed email address and store a record of each sent email, wherein the at least one seed email is configured to cause sending of tracking data to the server;
receive and store the tracking data, wherein the tracking data is associated with the sent email;
analyze the stored tracking data to determine deliverability statistics for the at least one email server and the at least one email address;
receive and store at least one actual user email address on the at least one email server in an email database;
send at least one email to the at least one actual user email address and store a record of each sent email, wherein the at least one seed email is configured to cause sending of tracking data to the server;
analyze the stored tracking data to determine conversion statistics for the at least one actual user email address, wherein the conversion statistics include at least viewing date and destination, wherein the destination corresponds to at least one folder of the at least one actual user email address;
generate at least one weight value by ranking conversion statistics based on at least viewing date and destination, wherein greater weight values correspond to greater display potential; and
fuse email database, campaign database, and weight values to generate an optimized seed list, wherein the optimized seed list includes email addresses with at least a predetermined display potential.

4. The system of claim 3, wherein the optimized seed list is further filtered based on user-selected criteria.

5. The system of claim 3, wherein the stored tracking data further includes domain, subject, and IP address data.

6. The system of claim 3, wherein the at least one email includes a campaign-specific x-header value.

7. The system of claim 3, wherein at least one weight value combines common domain email platforms to reduce quantity of unique domains in the stored tracking data.

8. The system of claim 3, wherein the at least one email includes a graphic, wherein upon opening the at least one email and fetching the graphic, and the at least one email further includes code for causing tracking data of the fetching of the graphic is caused to be sent to the server.

9. The system of claim 3, wherein the at least one email includes code causing tracking data to be sent to the server directly from the email server.

10. A method for providing optimized email campaign seed lists from tracking and monitoring email campaigns over a computer network, comprising the steps of:
receiving and storing at least one seed email address on at least one email server in an email database;
receiving and storing at least one campaign in a campaign database, wherein the at least one seed email address is associated with the at least one campaign;
sending at least one email to the at least one seed email address and store a record of each sent email, wherein the at least one seed email is configured to cause sending of tracking data to the server;
receiving and storing the tracking data, wherein the tracking data is associated with the sent email;
analyzing the stored tracking data to determine deliverability statistics for the at least one email server and the at least one email address;
receiving and storing at least one actual user email address on the at least one email server in an email database;
sending at least one email to the at least one actual user email address and storing a record of each sent email, wherein the at least one seed email is configured to cause sending of tracking data to the server;
analyzing the stored tracking data to determine conversion statistics for the at least one actual user email address, wherein the conversion statistics include at least viewing date and destination, wherein the destination corresponds to at least one folder of the at least one actual user email address;
generating at least one weight value by ranking conversion statistics based on at least viewing date and destination, wherein greater weight values correspond to greater display potential; and
fusing email database, campaign database, and weight values to generate an optimized seed list, wherein the optimized seed list includes email addresses with at least a predetermined display potential.

11. The method of claim 10, wherein the optimized seed list is further filtered based on user-selected criteria.

12. The method of claim 10, wherein the stored tracking data further includes domain, subject, and IP address data.

13. The method of claim 10, wherein the at least one email includes a campaign-specific x-header value.

14. The method of claim 10, further comprising the step of aggregating common domain email platforms to reduce quantity of unique domains in the stored tracking data.

15. The method of claim 10, wherein the at least one email includes a graphic, wherein upon opening downloading the graphic file the tracking data is reported to the server.

16. The method of claim 10, wherein the tracking data is sent to the server directly from the email server.

17. A system for dynamically generating and presenting email campaign content based on platform, comprising:
a server operating an email campaign platform, wherein the server is further configured to:
receive at least one email campaign message;
receive information indicating at least one device model;
generate at least one virtual representation of the at least one email campaign message as the at least one message would render on the at least one device model; and
display the at least one virtual representation to a user.

18. A system of claim 17, wherein the server is further configured to:
receive and store device data associated with an email address, wherein the device data includes rendering identifiers;
weigh stored device data to determine greatest device frequencies; and
generate a rendering for the device with the greatest device frequency.

19. A system of claim 17, wherein the server is further configured to:
receive rendering capability data for the at least one device model;
perform the generate and display steps constrained by the rendering capability data; and
record and store a time value to complete the perform step.

20. A system of claim 18, wherein the server is further configured to send the rendering to an email recipient if the email recipient views an email with a device matching the device with the greatest device frequency.

21. A system of claim 18, wherein:
the rendering is a plurality of renderings; and
the device is a plurality of devices.
